(19) United States
(12) Patent Application Publication
(10) Pub. No.: US 2009/0126459 A1
(43) Pub. Date: May 21, 2009

(54) FUNCTIONAL ASSEMBLY AND METHOD OF OBTAINING IT

(75) Inventor: REINHOLD WIMBERGER-FRIEDL, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,766

(22) PCT Filed: May 4, 2006
(86) PCT No.: PCT/IB06/51401

§ 371 Date: Nov. 19, 2007

(30) Foreign Application Priority Data
May 19, 2005 (EP) 05104256.2

(51) Int. Cl. G01N 27/00; H01B 5/00

(52) U.S. Cl. 73/31.05; 73/64.56; 174/126.1

(57) ABSTRACT

The invention relates to a functional assembly, for instance a biosensor, and to a method to obtain it. The assembly comprises a functional element (2), aimed to interact at its functional side with a sample fluid, and, electrically connected thereto through electrical connection means, an interconnect substrate (4) for supporting the element and transmitting signals. The interconnect substrate is provided with, an opening that gives access to the functional side of the functional element. The transition of the opening to the functional element is formed by a sidewall (5a), extending substantially over the circumference of the opening, whereby the average slope of the sidewall (5a) with respect to the plane (5b) of the functional element is less than 60 degrees. The assembly provides a transition to the functional element (2), having smooth and self-stratifying sidewalls, which allows a homogeneous filling of only small amounts of sample fluids.

The invention relates to a functional assembly, comprising a functional element, aimed to interact at its functional side with a sample fluid, and, electrically connected thereto, an interconnect substrate for supporting the element and transmitting signals, which interconnect substrate provides sample fluid access to the functional surface of the functional element. The invention also relates to a method of obtaining the functional assembly. The invention particularly relates to a functional assembly, used as a biosensor.

Functional assemblies, and in particular biosensors, are increasingly used in the art. Biosensors are generally based on immobilising and binding a biological substance onto a sensor substrate. Through some kind of interaction with the sensor or functional element, the presence of a particular target substance in the sample fluid can typically be detected. Since contacting the fluid, for instance a bodily fluid, creates a risk of infection and contamination, the sensor is usually disposed of upon finalising the functional action. Due to the desire to keep the cost involved in testing such biological sample fluids as low as possible, there is a need to keep the cost of the disposable sensor as low as possible.

In order to be able to communicate with the environment, functional elements are generally supported by and electrically connected to an interconnect substrate, which is subsequently connected to an instrument for read-out, for performing some operation, and/or otherwise. The electrical signals produced and/or received by the sensor and/or resulting from the interaction with the sample fluid, are transmitted through the interconnect substrate to auxiliary apparatus for further processing. When connecting the functional element to the interconnect substrate it obviously is important to ensure that the functional side of the functional element, for instance an active sensor surface, is accessible for the sample fluid. Since in many cases only minute amounts of sample fluid are available for testing and/or interaction, it is important to be able to introduce the sample fluid to the active side of the functional element in a way that ensures good interaction with the functional element. For reasons of cost, it would be highly desirable to integrate the sensor with the micro fluid channels system of the functional assembly. A micro fluid channel, which may for instance be provided between the interconnect substrate and a cover applied to the functional assembly serves to introduce the sample fluid to the active side of the functional element.

In such highly desirable compact functional assembly designs, the electrical interconnect between functional element and interconnect substrate will in general be very close to the fluid system. This poses problems of adequate introduction of the sample fluid onto the active side of the functional element. Indeed, when the sensor surface needs to be refreshed it is mandatory for a good interaction between newly introduced sample fluid and functional element, that the flow of the sample fluid is ‘well behaved’ and is as homogeneous as possible across the sensor surface. It should for instance be avoided that fluid gets trapped at and/or around the functional element, for instance behind corners and/or other obstacles, or that parts of the area adjacent to the active side exhibit low convection levels. This is difficult to achieve in compact designs, where the electrical interconnect for instance easily interferes with the fluid channels and/or the area adjacent to the active side. Tuning of the technology used for the interconnect with the way the fluid channels and the area adjacent to the active side of the functional element are sealed, is of critical importance to the success of disposable biosensors and/or other functional elements.

It is an object of the present invention to provide a functional assembly that is cost effective and yet enables efficient and excellent interaction between sample fluid and functional element.

This and other objects are achieved by a functional assembly, having the technical characteristics of claim 1.

Providing the interconnect substrate according to the invention, with an opening giving access to the functional side of the functional element and providing a transition of the opening to the functional element in the form of a sidewall, extending substantially over the circumference of the opening, whereby the average slope of the sidewall with respect to the plane of the functional element is less than 60 degrees, yields a functional element in which excellent interaction between functional element and sample fluid is achieved.

The slope of the sidewall with respect to the plane of the functional element is defined as the outer angle between the sidewall and the plane of the functional element. The inner angle obviously is the complement of the outer angle (180 degrees minus outer angle). Since according to the invention the average slope of the sidewall is less than 60 degrees, the transition between the opening of the interconnect substrate and the active side of the functional element is relatively flat.

It has advantages to characterize the functional assembly in that the average slope of the sidewall with respect to the plane of the functional element is less than 45 degrees, more preferably less than 30 degrees, and most preferably less than 15 degrees. The flatter the sidewall extends from functional element to the opening in the interconnect substrate, the less disturbed will be the sample fluid flow to the area adjacent to the active side of the functional element.

In the context of this application, the area adjacent to the active side of the functional element is referred to as the interaction area hereinbelow. It should be understood that this interaction area extends from sidewall to sidewall, and may encompass several sensors and/or active surfaces and/or passive surfaces, for instance when multiple sensors are incorporated in one chip. Also when referring to a sidewall in the specification, it is to be understood that multiple sidewalls may be meant. It may for instance be possible to enclose a substantially rectangular interaction area (seen from above) with four differently shaped sidewalls, as long as each sidewall has the technical characteristics of the invention.

Although not essential to the invention, the functional assembly preferably further comprises a fluid channel system for leading the sample fluid to the interaction area. Such fluid channel system is generally defined between the facing surfaces of the interconnect substrate and a cover, provided for instance on top of the interconnect substrate. This allows to supply the sample fluid to the interaction area in a continuous way, if desirable, which further improves the efficiency of the assembly. In this embodiment sample fluid is forced through the fluid channel system into the interaction area. Providing a smooth transition from the fluid channel system to the interaction area, wherein the actual measurement or otherwise is carried out, is an important feature of the invention.

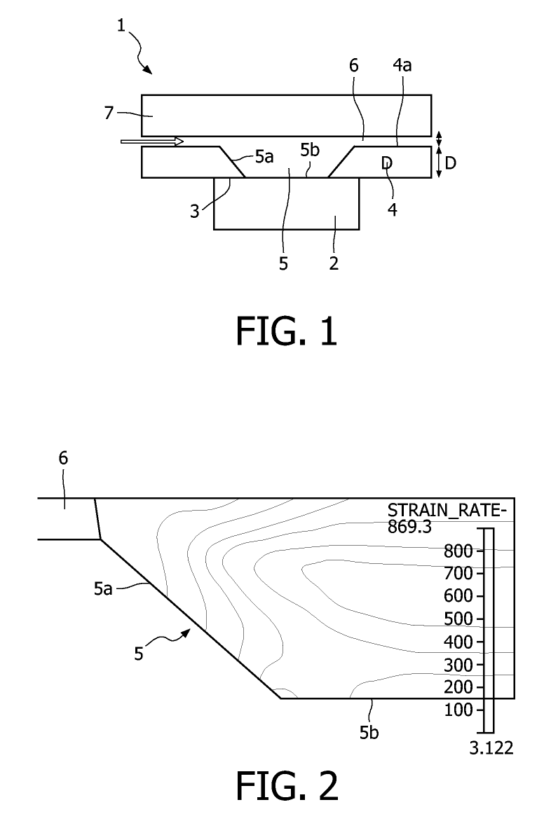

In a first embodiment according to the invention, the electrical interconnect substrate may for instance be a molded interconnect assembly (MID), produced by injection molding of a suitable polymer, as shown in FIG. 1. The fluid channel system is defined by the area between the facing surfaces of the MID and a cover, provided on the MID. The interaction area in the form of a shallow volume actually forms part of the fluid channel system in this embodiment. MID-technology offers the possibility to shape the fluid channel and the fluid interaction area directly in the MID. The cover itself may be profiled such that it conforms substantially to the shape of the interaction area, i.e. it more or less follows the contour thereof. It is also possible to form fluid channels in the cover itself and/or in the MID.

According to the invention, the transition between the opening of the interconnect substrate and the functional element should be gradual, i.e. sloped at an angle of at least less than 60 degrees. Moreover, it has advantages when the total height as measured from the bottom of the interaction area to the upper delimiting plane of the opening is as small as possible. When use is made of a fluid channel system, the total height of the interaction area should preferably be of the order of magnitude of the average height of the fluid channel system, or lower. The ratio of the fluid interaction and average fluid channel system heights is preferably chosen lower than 1:1, more preferably lower than 1:3, most preferably lower than 1:5. The lower the ratio, the less disturbed the flow of sample fluid when entering the interaction area from the fluid channel system.

In absolute terms, preferred functional assemblies have a sidewall (or alternatively an interaction area) with a total height of less than 100 μm, since the sample fluid is then minimally or not disturbed when flowing to the functional element. Even more preferred is a total height of less than 50 μm, most preferred less than 35 μm. The total height is defined as the shortest distance between the plane of the functional element and the upper delimiting plane of the interconnect substrate.

Although it is in principle possible with MID-technology to produce an interaction area with relatively smooth walls and a gradual transition from and to the micro fluid channels, there is a limit as to the achievable shallowness of the interaction area. Indeed, the MID preferably has a certain height in order to achieve the necessary mechanical integrity and manufacturability. Since fluidic channels between the MID and cover facing surfaces are typically shallower than the thickness of the MID, as may be appreciated from FIG. 1, the fluid channel dimensions increase at the height of the functional area, i.e. when entering the interaction area. Since a fast measurement—or interaction in general—requires a good replenishment of the fluidic sample at the functional element surface, convection should preferably be as high as possible. As illustrated by FIG. 2, which shows the calculated strain rate contours in the cross-section of a MID design, according to the first embodiment of the invention, convection is strongly reduced at the bottom of the interaction area. In this area however, convection is preferably elevated, since it is exactly there where the functional element is positioned and the actual measurement and/or interaction is carried out. The functional assembly according to the invention is therefore preferably characterized in that the slope of said sidewall(s) varies smoothly between the functional element and upper delimiting plane. This embodiment further improves the fast and, especially, homogeneous replenishment of sample fluids. Moreover, there is less risk of entrapment of particles, air bubbles, and the like. In the context of this application, with a smoothly varying slope is meant a slope that does not change abruptly in the transition from opening to functional element, especially not from a non-zero slope angle to a near-zero angle (which slope corresponds to the plane of the functional element).

The sidewall(s) with smoothly varying slope may be obtained by all methods known in the art. It is for instance possible to obtain these walls by using MID-technology, i.e. by injection molding of a suitable polymer, for instance an epoxy resin in a mold with the desired smoothly varying shape. It is also possible to obtain said sidewall(s) by cutting out a hole in a polymer plate or the like, using an appropriate tool. It should be noted that in the context of the application, the average slope of the sidewall is defined as the slope of the line, connecting the end points of the wall.

Another preferred functional assembly is characterized in that it comprises an interconnect substrate of a substantially polymeric foil (hereinafter also referred to as polymeric foil), provided with an opening, giving access to the functional side of the functional element, and that the sidewall extends from the functional element to the edge of the opening with an average slope, as defined above, of less than 60 degrees. In this embodiment, the sidewall forms a separate entity, distinct from the interconnect substrate, which contains the opening. The edge material forming the sidewall covers a substantial part of the inner peripheral surface (i.e. the surface facing the functional element) of the interconnect substrate. The material used to make the sidewall is preferably different from the material of the polymeric foil, although these materials may also be similar or substantially identical. Preferably, the planes of the polymeric foil and of the functional element extend substantially parallel to each other. Since the polymeric foil is generally flexible, it is however also possible that the polymeric foil exhibits some curvature, which may also be the case for the functional element if desired.

This preferred embodiment provides the possibility to adjust the total height of the interaction area, independent of the dimensions of the interconnect substrate. This is very advantageous, especially when only small fluid sample volumes are available.

It should be understood that by substantially polymeric foil is meant any foil, based on polymeric material, but possibly also comprising other additives, for instance mineral additives, and/or other materials, such as metal particles and/or flakes and/or foil, and the like. In order to be able to transmit electrical signals, the polymeric foil also comprises conducting, for instance metallic, interconnects.

The transition between the opening in the interconnect substrate and the functional element according to the invention preferably comprises sidewall(s) that extend smoothly between the functional element and the upper delimiting plane of the opening. Seen from above however the sidewall (s) may enclose an area having any shape. Polygonal shapes, such as rectangular, triangular, and the like, having relatively sharp corners are possible. It is also possible to adopt a channel-like shape. Preferred functional assemblies, however, have interaction areas with sidewall(s) extending smoothly over at least part of the circumference of the opening. Such preferred interaction areas are provided with rounded-off corners and/or are circular and/or elliptical, and so on.

As already referred to above, the total height of the interaction area of the functional element according to the invention should preferably be limited. In the context of embodiments of the invention, employing an interconnect substrate in the form of a substantially polymeric foil, the total height of the interaction area depends a.o. on the thickness of the interconnect substrate, in the case of the polymeric foil. The interconnect substrate preferably has a thickness of between 5-100 μm. Such polymeric foils are readily available. In order to further improve the interaction between sample fluid and functional element, the interconnect substrate more preferably has a thickness of between 10-50 μm, most preferably between 15-35 μm.

The invention also relates to a method of obtaining the functional assembly. The method of obtaining the functional assembly according to the invention more particularly provides an interconnect substrate with an opening giving access to the functional side of the functional element, and comprises the steps of providing electrical connection means onto interconnect substrate and/or functional element, positioning the functional element and the interconnect substrate adjacent to each other, so that an electrical connection is provided between them, thereby defining a gap between at least part of the facing surfaces of the interconnect substrate and the functional element; and at least partly sealing said gap. The interconnect substrate and functional element are preferably positioned such that the peripheral surface area of the functional element overlaps the peripheral surface area of the opening in the interconnect substrate. By adopting the method according to the invention a functional device having the above-mentioned advantages is obtained in a cost effective and straightforward manner.

The method is preferably characterized in that sealing of the gap is carried out by

introducing a liquid sealing material between the facing surfaces of the interconnect substrate and the functional element;

allowing said liquid sealing material to substantially fill at least part of the gap;

solidifying the liquid sealing material.

The method according to the invention produces a functional assembly design which combines standard electrical interconnect technology with a simple and powerful way of creating a micro fluidic channel with smooth and self-aligning walls. The height of the gap between substrate and functional element is generally defined by the height of the electrical connection means, for instance bond pads, provided between the facing surfaces. After having introduced the liquid sealant material into the gap, this material flows around the electrical connection means, thereby effectively shielding the connection means from the fluidics. By adopting the method according to the invention, a functional assembly is obtained that is compact, i.e. allows a good interaction with small amounts of sample fluid only, and comprises an interaction area having a smooth and self-stratifying wall. This enhances the quality and consistency of the interaction between the functional element, for instance a sensor, and the sample fluid, for instance a biological fluid, considerably. An additional advantage of the method according to the invention is that the sidewall is self-aligning. Even if the interconnect substrate and the functional element are somewhat misaligned, for instance in the height direction, the method ensures that a smooth sidewall is formed, having the desired characteristics, i.e. without sharp corners and/or irregularities, possibly leading to undesired very broad residence time distributions. Also, pinning of air inclusions in the interaction area that may cause problems with the actual measurement and affect accuracy and reproducibility, is prevented.

When referring to a functional element and an opening in the interconnect substrate, it is to be understood that it is possible to combine more than one functional element with an interconnect substrate, which is then provided with several openings.

The functional assembly according to the invention has the additional advantage that it may comprise a fluid interaction area with smooth walls and a height substantially smaller than known in the art. A preferred embodiment of the assembly and method according to the invention is characterized in that the interaction area (or the sidewalls) of the functional element has a height of less than 100 μm, more preferably less than 50 μm, even more preferably less than 35 μm.

Such heights are readily achieved, for instance by suitably selecting the thickness of the interconnect substrate. According to the invention, the interconnect substrate may be any interconnect substrate, known in the art. It is for instance possible to use a flexible foil of polymeric material, printed circuit board, an optical substrate and/or a polymeric sheet or molded component.

The liquid sealing material, also referred to as the underfill, may be any fluid that can be vitrified and has sufficient sealing and adhesive power. Preferably a curable resin is used for this purpose. Curing may be achieved through thermal activation, by radiation, and/or any other means known in the art. Particularly preferred resins include epoxy resins, due to their high adhesive bonding properties. Even more preferred is to fill the resins with at least one inorganic filler, such as for instance glass beads and the like, in order to reduce curing shrinkage and thermal expansion. The underfill may be an electrically insulating or conductive material.

In another preferred embodiment of the method according to the invention, a conductive material is used having anisotropic conductivity. This anisotropic conductivity may for instance be induced by providing the sealant material with a filler, coated with conductive material, for instance a metal, and in particular gold. When sufficiently compressing such material, the coated fillers at least partly contact each other in the compression direction, thus establishing electrical conduction in this direction. In this embodiment, it becomes possible to combine the electrical bonding step—i.e. making the electrical connection between functional element and interconnect substrate—with the sealing operation of the fluid interaction area. The sealing material with anisotropic conductivity then simultaneously acts as enclosure to the interaction area and as electrical connection with the interconnect substrate.

The functional element used in the method and assembly according to the invention may be a sensor chip, made of silicon, glass, ceramic and/or polymeric material, depending for instance on the kind of sensing principle to be used. According to the invention, it is generally preferred to manufacture the active sensor on a separate substrate and integrate this assembly in a, preferably low-cost, substrate for the fluidics, which has different requirements. In order to provide an active sensor surface, the hybrid substrate thus produced is then treated chemically and/or biochemically in the required way, for instance by applying additional layers or patterned structures. It is also possible to use functional elements in the form of an actuator and/or heater and/or other electromagnetic assembly.

According to the invention, several sensing and/or other functional elements may be integrated on different separate substrates on a single interconnect substrate to create a system usually referred to in the art as a lab-on-a-chip or micro-TAS.

According to a particularly preferred method of the invention, means are provided on the surface of the functional element facing the interconnect substrate for withholding (also referred to below as pinning) the flow of a liquid sealing material. This is usually done prior to introducing the liquid sealing material in the gap between the facing surfaces of functional element and interconnect substrate. The pinning means will after injection define the edge of the accessible sensor area. The pinning means, generally in the form of a ridge, may be made of photolithographic material with illumination, development and/or etching steps. A particularly suitable material in this respect is known in the art as SU-8. Alternatively, it is possible to use a virtual ridge by locally modifying the wetting behaviour of the sensor surface along a substantially closed contour, so that the flow of the underfill will during injection stop at the edge of the area on the sensor surface, enclosed by the contour. Locally modifying the wetting behaviour of the sensor surface may for instance be performed by micro-contact printing of a hydrophobic ink, or by any other means, known in the art. In another embodiment, the pinning means may be provided by a ring of a suitable polymeric material, for instance thermoplastic polymers such as polyimides, and/or thermosetting polymers such as epoxies and the like. When using such a ring, the method according to the invention provides a sidewall, which will extend over the upper surface of the ring until the underfill is arrested at the inner edge of the ring. The method according to the invention therefore has the additional advantage that the ring structure will at least partly be embedded in the formed sidewall, and therefore will not interfere with the slope of the sidewall. It is therefore possible to obtain a sidewall with a substantially smooth free surface.

In order to be able to define micro fluidic channels or a fluid introduction area on the assembly, from which the fluid interaction area may be replenished, the integrated functional element and interconnect assembly is preferably provided with a cover. Besides defining fluidic channels, the cover also acts as a closure to the system. The cover may be applied in any suitable manner, for instance by adhesive and/or thermal bonding.

The method and assembly according to the invention will now be described in more detail with reference to the embodiments shown in the accompanying Figures without, however, being limited thereto.

FIG. 1 schematically shows a side view in cross-section of a first embodiment of the assembly according to the invention;

FIG. 2 shows a graph of the strain rate distribution in a cross-section of the interaction area of the first embodiment of the functional assembly;

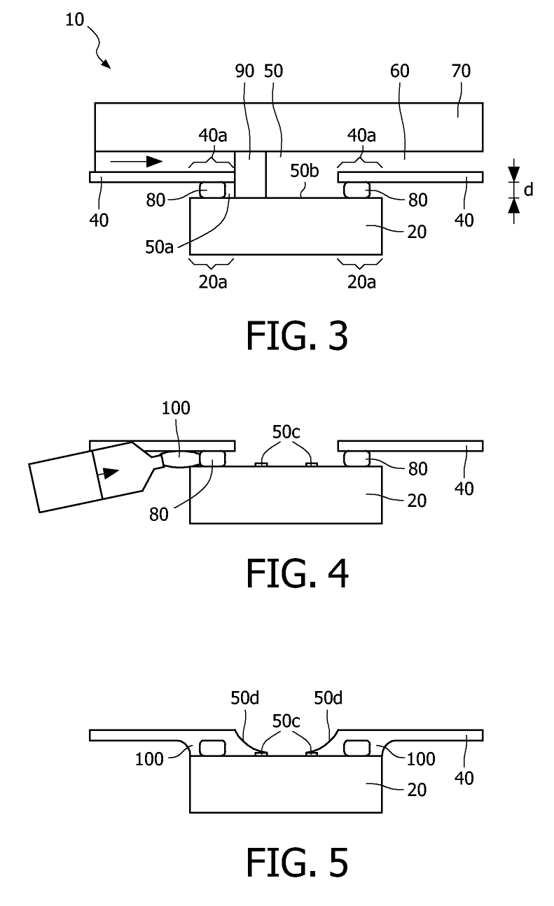

FIG. 3 schematically shows a side view in cross-section of a method step for obtaining a functional assembly according to the invention;

FIG. 4 schematically shows a side view in cross-section of a method step for obtaining a functional assembly according to the invention;

FIG. 5 schematically shows a side view in cross-section of another embodiment of the functional assembly according to the invention;

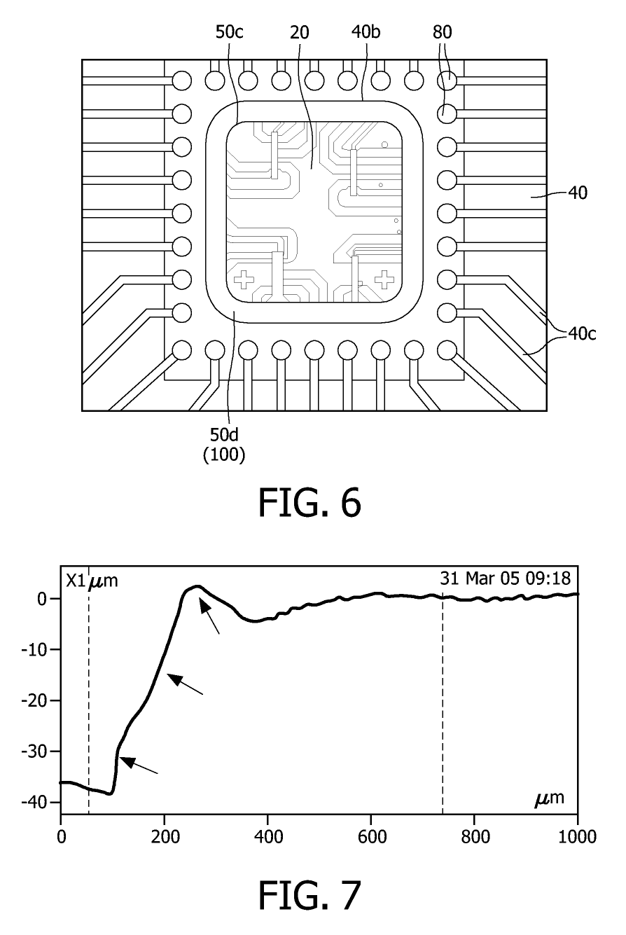

FIG. 6 schematically shows a top view of the embodiment of FIG. 5;

FIG. 7 shows a graph of the height profile of a sidewall of the embodiment of FIG. 5.

According to the invention, FIG. 1 shows a typical design of a first embodiment of the functional assembly 1 of the MID type. The sensor 2, provided with electrical interface 3 is mounted on an electrical interconnect substrate 4, made by injection molding of a suitable polymer. The fluid to be sampled is introduced in the interaction area 5 through a fluid channel system (or generally a fluid introduction area) 6 (see arrow). The fluid interaction area 5 is shaped directly in the interconnect substrate 4, which has a considerable thickness D, typically in the order of about 300 μm or more. In the embodiment shown, the assembly is provided with a cover 7, which together with the facing surfaces 4a of the interconnect assembly 4, defines the fluidic channels 6. The sidewall 5a of the interaction area 5 has a slope of about 60 degrees maximum. The slope of the wall 5a is defined as the outer angle, i.e. the angle formed by the parts denoted 3 and 5a in FIG. 1. The relatively flat sidewall 5a ensures that the transition between fluid channel 6 and fluid interaction area 5 is not abrupt, i.e. the step in height experienced by the sample fluid when transiting from the fluidic channel 6 into the interaction area 5 is gradual.

Further, as shown in FIG. 1, the height of the area 5 is about the same as the thickness D. This relatively high height leads to a reduced convection and, therefore, to a less than optimal mixing of the sample fluid at the bottom 5b of area 5. This is illustrated in FIG. 2, which shows the calculated strain rate contours in the fluid in the cross-section of the area 5 during flow from the entrance to the exit side (from left to right in FIG. 2). It is clear that the strain rate (the measure for convection) at the bottom 5b of the area 5 (adjacent to sensor 2) is about a factor of 30 lower than in the narrow entrance and exit sections of the fluidic channel 6. This is generally less desirable for a fast and homogeneous replenishment of sample fluids. In one improvement of the assembly according to the invention, the cover 7 is profiled such that it actually more or less conforms to the shape of the interaction area 5, i.e. follows the contour thereof. Although this embodiment improves convection considerably, it needs a careful alignment of the ‘mating’ surfaces of cover and interconnect substrate. If alignment is not optimal, the dimensions of the fluid channel system may locally become reduced, or local obstruction may even occur, especially when dimensions are small.

FIG. 5 shows another, preferred embodiment of the functional assembly according to the invention. This embodiment 10 makes use of a relatively thin interconnect substrate 40 of a flexible foil of substantially polymeric material. In order to have fluidic access to the active surface 50b of the sensor 20, the flexible foil 40 is provided with an opening at the height of the sensor 20 to give access for the fluid 90 to the active surface 50b of the sensor 20. The sensor 20 is electrically connected to the interconnect substrate 40 through electrical connections (bumps) 80.

This embodiment is manufactured by a method, as shown in FIGS. 3, 4 and 5. First a configuration as shown in FIG. 3 is provided. Herein the functional element 20 and the interconnect substrate 40 are positioned adjacent to each other with the aid of suitable positioning means (not shown), such that the peripheral surface area 20a of the functional element 20 overlaps the peripheral surface area 40a of the opening in the interconnect substrate 40. Such positioning may be provided by electrical connection means 80, attached to the interconnect substrate 40 and/or the periphery of the functional element 20. Both are positioned at some distance d from each other, thereby defining a gap between at least part of the facing surfaces of the interconnect substrate 40 and the functional element 20. Generally, although not essential to the invention, the functional element 20 is electrically connected over at least part of its peripheral area 20a to the interconnect substrate 40 along at least part of the peripheral area 40a of the opening with the aid of suitable attaching means 80. A suitable method to obtain such electrical connection is by ultrasonic bonding of Au bumps onto the Au contacts of the interconnect, but other methods such as soldering are also possible. Attaching means 80 may be any suitable attaching means, such as bonding pads and the like. In a preferred embodiment according to the invention, separate bonding pads 80 may be discarded. Bonding between the sensor 20 and the interconnect substrate 40 is then provided by the sealing material 100, described below. In order to establish an electrical connection between sensor 20 and interconnect substrate 40, either the bonding pads 80 or the sealing material should be electrically conductive, the latter preferably having anisotropic conductivity.

In order to obtain the desired interaction area 50 with smooth sidewalls 50d, withholding means 50c for a liquid sealing material 100 are preferably provided on the surface 50b of the functional element 20 facing the interconnect substrate 40. According to the invented method a liquid sealing material 100 is then introduced between the facing surfaces of the interconnect substrate 40 and the functional element 20, in an amount sufficient to substantially fill the entire peripheral area (20a, 40a). Capillary forces drive the liquid sealant material to spread between the bonding pads 80 (not visible in the cross-sectional views of FIG. 5). The flow of sealant 100 will automatically stop at the top edge of interconnect 40 and the edge, formed by withholding means 50c, thereby forming a substantially enclosed interaction area 50 with smooth inclined sidewalls 50d. The shape of the walls 50d is formed naturally by the meniscus of the liquid sealant material 100, introduced in the gap between functional element 20 and interconnect substrate 40.

After the liquid sealant material 100 has been introduced in this manner, it is solidified by thermal and/or radiation curing for instance. To produce electrical connection between interconnect substrate 20 and functional element 40, the electrical connection means 80 are provided by using a sealing material 100 having anisotropic electrical conductivity. The electrical connection between interconnect substrate and functional element is then provided by applying sufficient pressure to the sealing material after introduction and flow, but before at least partial solidification.

If desired, a cover 70 may be applied on top of the assembly, thus defining an area 60 through which the fluid 90 to be analysed may be introduced into the interaction area 50.

FIG. 6 shows a top view of an embodiment of the assembly according to the invention, which is obtained by the invented method. Shown is a sensor chip 20, bonded through bonding pads 80 to a flexible interconnect substrate 40. In this embodiment, the bonding pads 40 are regularly arranged around the peripheral area of the opening of the interconnect substrate 40. The opening is defined by contour line 40b. The bonding pads 80 are connected to peripheral apparatus (not shown) through copper leads 40c. It may be advantageous to make the interconnect substrate 40 of a transparent flexible foil for easy visibility, although this is not essential for the invention. On the sensor 20 the pinning means in the form of ridge 50c forming a substantially closed contour is shown. The underfill 100 has formed a smooth inclined wall 50d, exactly as intended by the method according to the invention. It may be appreciated from FIG. 6 that the pinning means 50c (referred to as SU-8 ridge) on the sensor 20 is not exactly aligned with the opening in the flexible interconnect substrate 40. It is an additional advantage of the method of the invention that the slope of the sidewalls 50d adjusts itself during injection of the liquid sealant material 100. The method according to the invention is in other words self-aligning and stratifying.

The slope of the sidewalls 50d obtained by the method of the invention shows a gradual transition as demonstrated by the result of a profilometer measurement across the edge (FIG. 7). The total height of the sidewalls is only about 35 μm (as compared to more than 300 μm in the less preferred embodiment using an MID) and the average slope is about 14 degrees (note that in FIG. 7 the scaling of x-axis and y-axis is different). This provides a very smooth transition between the fluid channel 60 and the fluid interaction area 40, which ensures an excellent and undisturbed flow to the interaction area 40.

The assembly according to the invention may be used in a wide variety of applications, such as for instance as a general purpose sensor, a biosensor, environmental, food, health, and/or diagnostic sensor, lab-on-a-chip, integrated sample treatment and sensor assemblies, micro-TAS, and so on, for instance comprising heating and/or cooling elements which are particularly useful for DNA amplification (e.g. by PCR) and hybridisation assays. Other suitable applications include for instance ICs with integrated electronic cooling, and LEDs or other compact light sources with integrated cooling.

1. Functional assembly, comprising a functional element, aimed to interact at its functional side with a sample fluid, and, electrically connected thereto through electrical connection means, an interconnect substrate for supporting the element and transmitting signals, which interconnect substrate is provided with an opening giving access to the functional side of the functional element, characterized in that, the transition of the opening to the functional element is formed by a sidewall, extending substantially over the circumference of the opening, whereby the average slope of the sidewall with respect to the plane of the functional element is less than 60 degrees.

2. Functional assembly according to claim 1, characterized in that the average slope of the sidewall with respect to the plane of the functional element is less than 30 degrees.

3. Functional assembly according to claim 1, characterized in that the slope of the sidewall varies smoothly between the plane of the functional element and the upper delimiting plane of the opening.

4. Functional assembly according to claim 1, characterized in that it further comprises a fluid channel system for leading the sample fluid to the active side of the functional element.

5. Functional assembly according to claim 1, characterized in that the total height of the sidewall measured from the plane of the functional element to the plane of the opening is less than 100 μm.

6. Functional assembly according to claim 5, characterized in that the total height of the sidewall measured from the plane of the functional element to the plane of the opening is less than 50 μm.

7. Functional assembly according to claim 1, characterized in that it comprises an interconnect substrate of a substantially polymeric foil, provided with an opening, giving access to the active side of the functional element, and that the sidewall extends from the functional element to the edge of the opening.

8. Functional assembly according to claim 7, characterized in that the planes of the polymeric foil and of the functional element extend substantially parallel to each other.

9. Functional assembly according to claim 1, characterized in that the sidewall extends smoothly over at least part of the circumference of the opening.

10. Functional assembly according to claim 1, characterized in that the material of the sidewall differs from the material of the interconnect substrate.

11. Functional assembly according to claim 1, characterized in that the interconnect substrate has a thickness of between 5-100 μm.

12. Functional assembly according to claim 11, characterized in that the interconnect substrate has a thickness of between 10-50 μm.

13. Method for obtaining a functional assembly according to claim 1, wherein the interconnect substrate is provided with an opening giving access to the functional side of the functional element, the method comprising the steps of
providing electrical connection means on either interconnect substrate and/or functional element;
positioning the functional element and the interconnect substrate adjacent to each other, so that an electrical connection is provided between them, and the peripheral surface area of the functional element overlaps the peripheral surface area of the opening in the interconnect substrate thereby defining a gap between at least part of the facing surfaces of the interconnect substrate and the functional element;
at least partly sealing said gap.

14. Method according to claim 13, characterized in that sealing of the gap is carried out by
introducing a liquid sealing material between the facing surfaces of the interconnect substrate and the functional element;
allowing said liquid sealing material to substantially fill at least part of the gap;
solidifying the liquid sealing material.

15. Method according to claim 14, characterized in that, prior to introducing the liquid sealing material between the facing surfaces, means for withholding flow of the liquid sealing material are provided on the surface of the functional element facing the interconnect substrate.

16. Method according to claim 13, characterized in that the electrical connection means are provided by a sealing material having anisotropic electrical conductivity, and that the electrical connection between interconnect substrate and functional element is provided by applying sufficient pressure to the sealing material between steps b and c.

17. Functional assembly, obtainable by the method according to claim 13.

18. The use of a liquid sealing material with anisotropic conductivity in providing an electrically conducting connection between the functional element and the interconnect substrate of a functional assembly, in particular a biosensor.
